(19) United States
(12) Patent Application Publication
(10) Pub. No.: US 2009/0102792 A1
(43) Pub. Date: Apr. 23, 2009

(54) USER INPUT DEVICE WITH PHOSPHORESCENT INDICATOR

(75) Inventor: Mark W. Casebolt, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/875,532

(22) Filed: Oct. 19, 2007

(51) Int. Cl. G06F 3/033

(52) U.S. Cl. 345/166

(57) ABSTRACT

A user input device for use with a computing device is provided. The user input device may include a body, a light source coupled to the body and configured to produce a source light, and a phosphorescent portion positioned proximate to the body and configured to emit a phosphorescent light upon being exposed to the source light.

### BACKGROUND

During installation, troubleshooting, and use of an optical mouse, a user may desire to determine whether the mouse is operational. Some optical mice emit a visible light that is reflected off a tracking surface to track mouse movement, and a user may identify that the mouse is operational by viewing this light, or its subsequent illumination of adjacent surfaces. However, this light may be weak and difficult to see for some users. Further, if invisible light, such as infrared light, is emitted from a mouse, no visible indication is provided to the user that the mouse is operational.

On some prior infrared mice, a second, powered indicator light has been provided to indicate to the user that the mouse is operational. However, adding a powered indicator light to a mouse consumes valuable power resources. This may be undesirable, especially for battery-operated mice, for which power conservation is a factor for achieving longer mouse operation time and lighter mouse weight.

### SUMMARY

A user input device for use with a computing device is provided. The user input device may include a body, a light source coupled to the body and configured to produce a source light, and a phosphorescent portion positioned proximate to the body and configured to emit a phosphorescent light upon being exposed to the source light. The source light may be invisible light and the phosphorescent light may be visible light. The phosphorescent light may provide an indicator to a user that the mouse is operational.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a side view of a user input device having body with a phosphorescent portion.

FIG. 2 is a bottom view of the user input device of FIG. 1.

FIG. 3 is a cross-sectional view of a phosphorescent portion of a body of the user input device of FIG. 1, including a phosphorescent layer and a substrate layer.

FIG. 4 is a cross-sectional view that illustrates another embodiment of a phosphorescent portion of the body of the user input device of FIG. 1, including a substrate layer embedded with a phosphor.

FIG. 5 is a flowchart of an embodiment of a method for use in manufacturing a user input device of FIG. 1.

### DETAILED DESCRIPTION

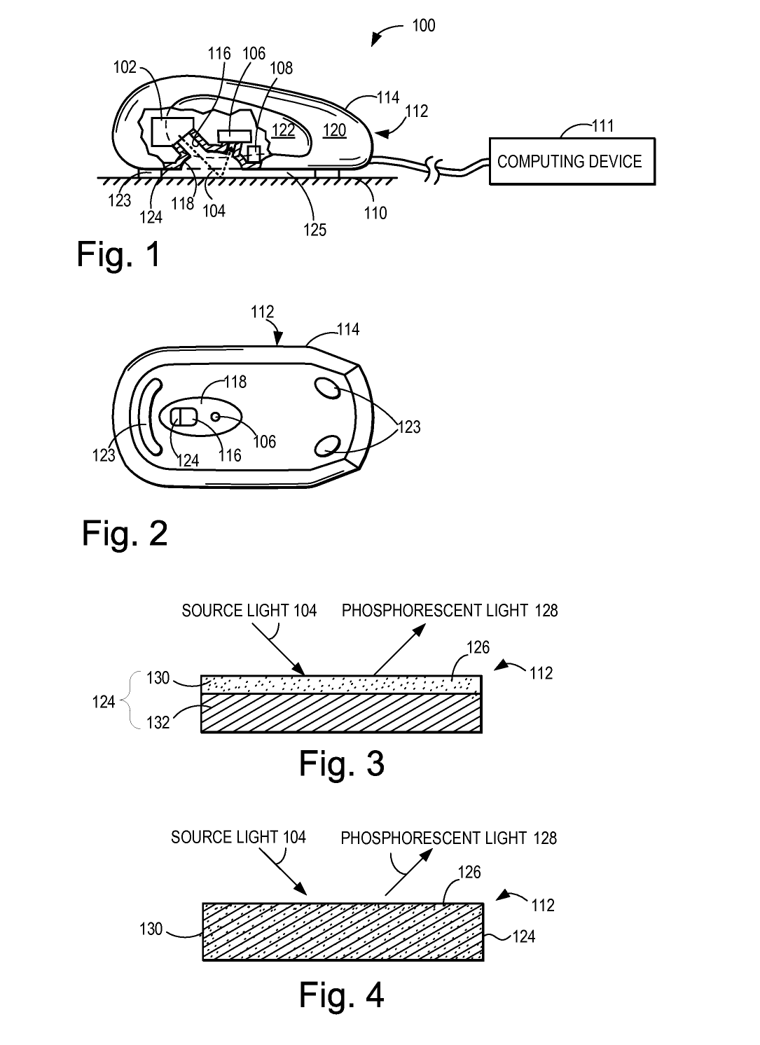

FIG. 1 illustrates a side view of a user input device 100, which may be an optical mouse, with a phosphorescent portion 124 that may serve as an operational indicator indicating an operational state of the user input device 100. FIG. 2 illustrates a bottom view of the user input device 100.

The user input device 100 may include a light source 102 for emitting a source light 104, a sensor 106 for sensing the source light 104 as it is reflected off a tracking surface 110 proximate to the user input device 100. The user input device 100 may include a controller 108 configured to receive output from the light sensor 106 and calculate a movement of the user input device over the tracking surface 110 based on the output. The calculated movement may be transmitted to a computing device 111, via a wired or wireless communications link, for downstream processing.

The light source 102 may be a visible light source configured to produce a source light that is a visible light, such as a light emitting diode (LED) light source for emitting a visible LED light. Alternatively, the light source 102 may be an invisible light source configured to produce a source light that is an invisible light, such as a ultra-violet (UV) light source for emitting a UV source light or an infrared light source for emitting an infrared (IR) source light. The light source 102 may alternatively be a laser light source, such as a vertical cavity surface-emitting laser (VCSEL).

The user input device 100 may further include a body 112. The body 112 may include an outer casing 114, an aperture 116 through which the source light 104 is emitted from the light source 102, and an aperture well 118 in which the aperture 116 is positioned. As illustrated in FIG. 2, aperture well 118 may open to a bottom surface of the user input device 100 to define an oval shape, and the sensor 106 and source light 104 may be positioned substantially along a longitudinal axis of the oval. The outer casing 114 may further include an opaque portion 120 that is substantially opaque to visible light and a translucent portion 122 that is translucent to light. The body 112 may further include a plurality of supports 123 that raise the body 112 to be spaced apart from the tracking surface 110. When the user input device 100 is positioned on the tracking surface 110 as shown, the body 112 and the tracking surface 110 may define a gap 125 between the body and the tracking surface 110.

As illustrated in FIGS. 3 and 4, the body 112 of the user input device 100 may include a phosphorescent portion 124 including a phosphor 126. The phosphorescent portion 124 may be positioned at a location proximate to the body 112 that is exposed to source light 104 from the light source 102, and may be configured to emit a phosphorescent light 128 upon being exposed to the source light 104. The phosphorescent light 128 may be visible light that is visible to human eyes, thereby providing an indication of an operational state of the user input device 100. One example of an operational state is a state in which the user input device is powered and communicating with the computing device correctly, making the mouse available for operation by a user. To illustrate, when the user input device 100 is powered, the light source 102 emits the source light 104, consequently causing the phosphorescent light 128 to be emitted by the phosphor 126 of the phosphorescent portion 124, thus indicating that the user input device 100 is powered. On the other hand, when the user input device 100 is unpowered, the light source 102 does not emit the source light 104 and the phosphorescent light 128 is not emitted by the phosphor 126 of the phosphorescent portion 124, thus indicating that the user input device 100 is unpowered.

As illustrated in FIG. 4, the phosphorescent portion 124 may be a portion of the body 112 in which the phosphor 126 has been embedded. For example, as illustrated in FIG. 4, the phosphorescent portion 124 may be a portion of the body 112, and the phosphorescent portion 124 may include a phosphorescent layer 130 embedded with the phosphor 126, and arranged in a single layer configuration.

As illustrated in FIG. 3, the phosphorescent portion 124 may alternatively include a plurality of layers, including a phosphorescent layer 130 embedded with the phosphor 126 and a substrate layer 132. In the illustrated embodiment of FIG. 4, the substrate layer 132 does not include a phosphor, but in some embodiments may include a phosphor. The phosphorescent layer 130 may be positioned adjacent the substrate layer 132. It will be appreciated that one or more intervening layers may be positioned between phosphorescent layer 130 and substrate layer 132. These intervening layers may or may not include a phosphor.

The phosphorescent layer 130 may be formed of a plastic embedded with the phosphor 126, and the single layer configuration of FIG. 4 may be formed in a single-shot injection molding process. Further, the multiple layer configuration of the phosphorescent portion 124 in FIG. 3 may be formed via a multiple-shot plastic injection molding process, such as a two-shot process, in which the substrate layer 132 is initially formed via an injection of a first plastic, and the phosphorescent layer 130 is subsequently formed adjacent the substrate layer 132 in a second injection of plastic.

Alternatively, the phosphorescent layer 130 may be a paint layer including a phosphor. Thus, the phosphorescent portion 124 may be formed via painting a paint including the phosphor to form the phosphorescent layer 130 on the substrate layer 132.

The phosphorescent layer 130 may be positioned in a location of the body 112 where the phosphorescent layer may be exposed to the source light 104. For example, the phosphorescent layer 130 may be positioned in the wall of the aperture 116 and/or the wall of the aperture well 118 of the body 112. With such a configuration, the phosphorescent light 128 may be visible to a user through the gap 125, and/or through the translucent portion 122.

When the source light 104 of the user input device 100 is on, the user input device 100 may be deemed to be operational, and therefore the emission of phosphorescent light 128 in response to the source light 104 may serve the purpose of indicating the operational state of the user input device 100 to the user. Therefore, the phosphorescent portion 124 may serve as an indicator that indicates the operational state of the user input device 100.

The phosphor 126 may be any suitable phosphorescent material that is configured to emit a phosphorescent light upon exposure to a source light. The phosphor 126 may emit a phosphorescent light when the source light is turned on, and the phosphor 126 may lose its phosphorescent light after the source light is turned off. In some embodiments the decay of the phosphorescent light 128 may be relatively fast so that the operational state is not mis-indicated as the source light turns on and off. In other embodiments the phosphorescent light 128 may persist for some time to compensate for the relatively aperiodic nature of optical tracking illumination. It will be appreciated that the phosphorescent portion may be partially transmissive, and positioned opposite the viewer from the source light 102, thereby stimulating re-radiation from the visible surface, such as the tracking surface 110. It will also be appreciated that the phosphorescent portion 124 may be opaque and reflective, and thus may be configured to re-radiate visible light from scattered stimulus light of adjacent objects or mouse surfaces, or from direct irradiation from the light source 102.

The phosphor 126 may be an up-converting phosphor that up-converts a source light 104 that is invisible, to a phosphorescent light that is visible to human eyes. For example, the source light 104 may be an infrared light, and the phosphor 126 may be configured to up-convert the infrared light to a phosphorescent light that is visible to human eyes. As an example, the phosphor 126 of the phosphorescent portion 124 may be configured to emit phosphorescent light having a wavelength between about 400 and 700 nm.

Alternatively, the phosphor 126 may be a down-converting phosphor that down converts a source light 104 that is invisible, to a phosphorescent light that is visible. For example, the source light 104 may be a UV light, and the phosphor 126 may be configured to down-convert the UV light to a phosphorescent light that is visible to human eyes.

The phosphor 126 may be configured to emit a phosphorescent light 128 of any suitable color. For example, the phosphor 126 may be a green, red, or yellow phosphorescent phosphor configured to emit a phosphorescent light 128 that is green, red, or yellow, as desired. Phosphor 126 may include, for example, zinc sulfide, strontium aluminate, or other pigment. The phosphor 126 may further include one or more of silver, magnesium, or copper. Other phosphor techniques that result in re-radiation also may be employed, such as homogeneous particle mixtures with specific resonance geometries.

In use, as shown in FIGS. 3 and 4, as the light source 102 is turned on and off in the user input device 100, which may occur when the user input device is installed on the computing device 111, or moved, etc., the source light 104 of light source 102 is flashed on and off, and in response, the phosphorescent light 128 emitted by the phosphorescent portion 124 phosphoresces to flash in-sync and/or increases and decreases its glow in response to the source light 104, indicating the operational state of the user input device 100 to the user. The timing, such as attack and decay, of the phosphorescent light 128 may be adjusted by selecting a suitable phosphor.

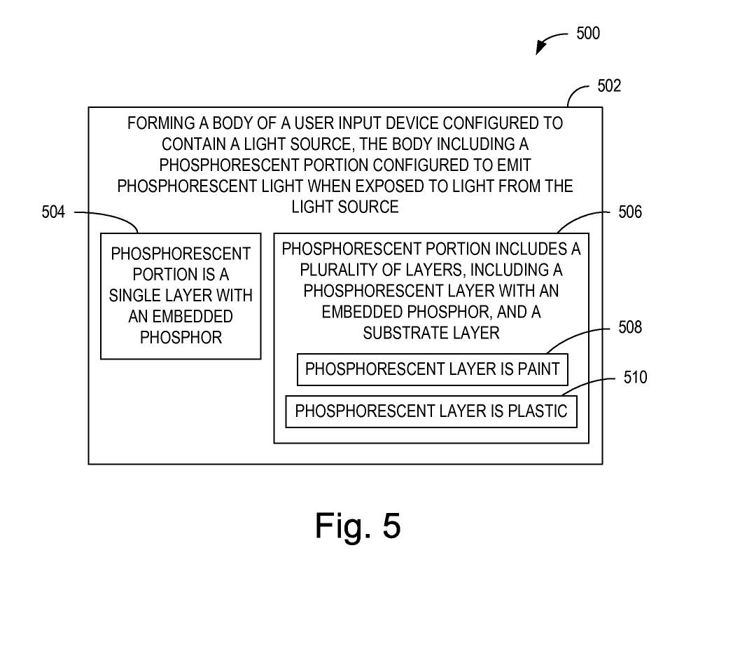

FIG. 5 illustrates an embodiment of a method 500 for use in manufacturing the user input device 100. At 502, the method may include forming a body of a user input device configured to contain a light source, the body including a phosphorescent portion configured to emit phosphorescent light when exposed to source light from the light source. As illustrated at 504, forming the body may include forming an outer casing of the body, the outer casing including the phosphorescent portion as a single layer of material embedded with a phosphor. The phosphorescent portion having the phosphorescent portion formed in a single layer may be manufactured of plastic according to a single shot injection molding process, for example.

As illustrated at 506, forming the body may include forming the phosphorescent portion to include a plurality of layers, including a phosphorescent layer embedded with a phosphor and a substrate layer. The phosphorescent layer may be selected from the group consisting of a paint layer and a plastic layer. For example and as shown at 508, the phosphorescent layer may be a paint layer, and the method may include painting the phosphorescent layer adjacent the substrate layer.

As shown at 510, the phosphorescent layer may be a plastic layer, and the method may include forming the phosphorescent layer adjacent the substrate layer, for example, by a two-shot injection molding process. As described above, the phosphorescent layer may be positioned on the body in a location such as an aperture or aperture well through which the source light of the light source passes. The source light may be visible light or invisible light, such as ultraviolet or infrared light. The phosphorescent light is typically visible, to provide an indication to the user that the mouse is active.

Using the above described devices and methods a user input device may be provided that conveniently indicates a state of the user input device while conserving power.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A user input device, comprising:
a body;
a light source coupled to the body and configured to produce a source light; and
a phosphorescent portion positioned proximate to the body and configured to emit a phosphorescent light upon being exposed to the source light.

2. The user input device of claim 1, wherein the source light is invisible light and the phosphorescent light is visible light.

3. The user input device of claim 2, wherein the source light is infrared light and the phosphorescent portion is configured to up-convert the infrared light to phosphorescent light that is visible.

4. The user input device of claim 2, wherein the source light is ultraviolet light and the phosphorescent portion is configured to down-convert the ultraviolet light.

5. The user input device of claim 1, further comprising a light sensor configured to detect source light reflected off a tracking surface, and a controller configured to receive output from the light sensor and calculate a movement of the user input device over the tracking surface.

6. The user input device of claim 1, wherein the light source is one of a light emitting diode or a vertical-cavity surface-emitting laser.

7. The user input device of claim 1, wherein the body includes an aperture adjacent the light source through which the source light passes, and the phosphorescent portion is positioned in the aperture.

8. The user input device of claim 1, wherein the body includes an aperture well positioned downstream of an aperture through which the source light is emitted, and the phosphorescent portion is positioned in the wall of the aperture well.

9. The user input device of claim 1, wherein the phosphorescent portion is a phosphorescent layer positioned proximate to the body.

10. The user input device of claim 9, wherein the phosphorescent layer is formed of a paint including a phosphor.

11. The user input device of claim 9, wherein the phosphorescent layer is a plastic layer embedded with a phosphor.

12. The user input device of claim 1, wherein the phosphorescent portion is a portion of the body in which phosphor has been embedded.

13. The user input device of claim 1, wherein the phosphorescent portion includes a phosphor including zinc sulfide.

14. The user input device of claim 13, wherein the phosphor further includes one or more of silver, magnesium, or copper.

15. The user input device of claim 1, wherein the phosphorescent layer is configured to emit phosphorescent light having a wavelength between about 400 to 700 nm.

16. A method for use in manufacturing a user input device, comprising:
forming a body of a user input device configured to contain a light source, the body including a phosphorescent portion configured to emit phosphorescent light when exposed to source light from the light source.

17. The method of claim 16, further comprising:
wherein forming the body includes forming the phosphorescent portion to be a single layer of material embedded with a phosphor.

18. The method of claim 16, wherein forming the body includes forming the phosphorescent portion to include a plurality of layers, including a phosphorescent layer embedded with a phosphor and a substrate layer.

19. The method of claim 18, wherein the phosphorescent layer is selected from the group consisting of a paint layer and a plastic layer.

20. A mouse input device for use with a computing device, the mouse input device comprising:
a body;
a light source coupled to the body and configured to produce an invisible source light;
a light sensor coupled to the body and configured to detect source light reflected off a surface;
a controller configured to receive output from the light sensor and calculate a movement of the user input device over the surface; and
a phosphorescent portion positioned on the body and configured to emit a visible phosphorescent light upon being exposed to the invisible source light;
wherein the phosphorescent portion is configured to be transmissive or reflective.
